(19) United States
(12) Patent Application Publication
(10) Pub. No.: US 2008/0085706 A1
(43) Pub. Date: Apr. 10, 2008

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,456

(22) Filed: Sep. 21, 2007

(30) Foreign Application Priority Data
Sep. 28, 2006 (JP) 2006-264749

(51) Int. Cl. H04Q 7/20; G08B 21/00; H04B 7/00

(52) U.S. Cl. 455/435.1; 340/686.6; 455/41.2; 455/456.1

(57) ABSTRACT

The invention provides a mobile device system and a mobile device that can flexibly respond to situations where the user carries a different combination of mobile devices on different days, and can prevent the mobile devices from being misplaced. The mobile device system includes three or more mobile devices, wherein each mobile device includes a device detection unit for periodically detecting other mobile devices located within a predetermined range of the mobile device, a function-restricting unit for restricting a predetermined function, and a control unit, and when two or more mobile devices of the other mobile devices detected by the device detection unit are no longer detected, the control unit operates the function-restricting unit.

### BACKGROUND OF THE INVENTION

1. Field of the Invention

The present invention relates to a mobile device system and a mobile device that are capable of quickly notifying misplacement of the mobile device.

This application is based on Japanese Patent Application No. 2006-264749, the content of which is incorporated herein by reference.

2. Description of Related Art

Recently, due to the diversification of information, when people go out, in many cases, they carry multiple mobile devices having various functions, such as mobile phones, laptop computers, information communication terminals, digital cameras, and music players (see Japanese Unexamined Patent Application, Publication No. 2002-9879).

Along with this trend, a technology for preventing users from forgetting to take their mobile device when going out or misplacing a mobile device outside the home has been proposed (see Japanese Unexamined Patent Application, Publication No. 2006-60544).

For example, Japanese Unexamined Patent Application, Publication No. 2006-60544 discloses a technology for periodically sending and receiving location information each other between a wireless key and a communication phone terminal, determining the distance therebetween on the basis of the information, and providing an alert when the determined distance becomes longer than a predetermined value when the user forgets to carry the mobile device.

### BRIEF SUMMARY OF THE INVENTION

A first aspect provides a mobile device system that includes three or more mobile devices, wherein each mobile device includes a device detection unit for periodically detecting other mobile devices located within a predetermined range of the mobile device, a function-restricting unit for restricting a predetermined function, and a control unit, and wherein, when two or more mobile devices of the other mobile devices detected by the device detection unit are no longer detected, the control unit operates the function-restricting unit.

A second aspect provides mobile device including a device detection unit for periodically detecting other mobile devices located within a predetermined range of the mobile device; a function-restricting unit for restricting a predetermined function; and a control unit, wherein, when two or more mobile devices of the other mobile devices detected by the device detection unit are no longer detected, the control unit operates the function-restricting unit.

### BRIEF DESCRIPTION OF THE SEVERAL VIEWS OF THE DRAWINGS

FIG. 1 illustrates the structure of a mobile device system according to a first embodiment.

FIG. 2 illustrates common components included in each mobile device of the mobile device system according to the first embodiment.

FIG. 3 illustrates example information stored in a storage unit of a mobile phone according to the first embodiment.

FIG. 4 is a flow chart illustrating the steps of a misplacement detection process executed in a control unit according to the first embodiment.

FIG. 5 illustrates an example display when a PDA and a personal computer are located in the vicinity of a mobile phone.

FIG. 6 illustrates common components included in each mobile device of a mobile device system according to a second embodiment.

### DETAILED DESCRIPTION OF THE INVENTION

A mobile device system according to the present invention includes three or more mobile devices, wherein each mobile device includes a device detection unit for periodically detecting other mobile devices located within a predetermined range of the mobile device, a function-restricting unit for restricting a predetermined function, and a control unit, and wherein, when two or more mobile devices of the other mobile devices detected by the device detection unit are no longer detected, the control unit operates the function-restricting unit.

According to this structure, each mobile device periodically detects other mobile devices within a predetermined range of the mobile device. In such a case, if two or more mobile devices of the other mobile devices that have been detected are no longer detected, the control unit operates the function-restricting unit to restrict a predetermined function. Here, when three or more mobile devices are carried, the possibility of misplacing two or more mobile devices at the same time is low. When two or more mobile devices are no longer detected, by restricting a predetermined function of these mobile devices, the misplaced mobile device can be prevented from being used by someone else. In contrast, when two or more mobile devices are misplaced, a function of the mobile devices being carried is restricted, allowing the user to quickly notice the misplacement.

In the mobile device system, the control unit of each mobile device may operate the function-restricting unit when a state in which two or more other mobile devices are not detected by the device detection unit is maintained for a predetermined period.

According to this structure, since the control unit operates the function-restricting unit when a state in which two or more other mobile devices are not detected by the device detection unit is maintained for a predetermined period, for example, a case in which the other mobile devices are temporarily not detected due to communication failure or the like can be prevented. In this way, erroneous detection of misplacement can be prevented.

In the mobile device system, each mobile device may further include a group registration unit for registering the other mobile devices detected by the device detection unit as a group, and the control unit of each mobile device may operate the function-restricting unit when two or more other mobile devices of the other mobile devices registered as a group in the group registration unit are no longer detected by the device detection unit.

According to this structure, since other mobile devices detected by the device detection unit are registered as a group in the group registration unit, the control unit can easily determine that two or more mobile devices are no longer detected by comparing the other mobile devices registered in the group and the other mobile devices detected by the device detection unit.

In the mobile device system, each mobile device may further include a registration-cancellation-area detection unit for detecting a registration cancellation area, and when the registration-cancellation-area detection unit detects that the mobile device is in the registration cancellation area, the control unit may cancel group registration in the group registration unit, and when the registration-cancellation-area detection unit detects that the mobile device is not in the registration cancellation area, other mobile devices detected by the device detection unit may be registered as a group in the group registration unit.

According to this structure, when the registration-cancellation-area detection unit included in each mobile device detects that the mobile device is in a registration cancellation area, the group registration in the group registration unit is cancelled, and when the registration-cancellation-area detection unit detects that it is not in the registration cancellation area, the other mobile devices carried together are registered as a new group in the group registration unit. Therefore, for example, by registering the user's home as the registration cancellation area, the combination of mobile devices carried by the user when leaving home can be registered as a group. In this way, even when the user carries a different combination of mobile devices on different days, appropriate group registration of the mobile devices can be always carried out in response.

In the mobile device system, each mobile device may further include a location-information acquisition unit for acquiring location information of the mobile device and a communication unit for communicating with other mobile devices, and the device detection unit of each mobile device may send the location information acquired by the location-information acquisition unit to other mobile devices using the communication unit and detect other mobile devices located within a predetermined range of the mobile device on the basis of location information of the other mobile devices received by the communication unit and the location information of the mobile device.

According to this structure, the location information acquired by the location-information acquisition unit of each mobile device is periodically sent to the other mobile devices by operating the communication unit. In this way, location information of the mobile devices is mutually sent and received among the mobile devices. In this way, since each mobile device can acquire the location information of the other mobile devices, other mobile devices located within a predetermined range of the mobile device can be detected on the basis of this location information and its own location information.

In the mobile device system, each mobile device may further include a short-range communication unit, and the device detection unit of each mobile device may send identification information assigned to that mobile device using the short-range communication unit and detect other mobile devices located within a predetermined range of the mobile device on the basis of whether or not identification information of other mobile devices is received by the short-range communication unit.

According to this structure, since the short-range communication unit of each mobile device sends identification information assigned to the mobile device, this identification information is received by other mobile devices located within the communication range of the short-range communication unit. In this way, other mobile devices located within a predetermined range of the mobile device can be easily detected on the basis of whether or not identification information is received.

A mobile device according to the present invention includes a device detection unit for periodically detecting other mobile devices located within a predetermined range of the mobile device; a function-restricting unit for restricting a predetermined function; and a control unit, wherein, when two or more mobile devices of the other mobile devices detected by the device detection unit are no longer detected, the control unit operates the function-restricting unit.

According to this structure, other mobile devices located within a predetermined range of the mobile device are periodically detected by the device detection unit. In such a case, if two or more mobile devices of the other mobile devices that have been detected are no longer detected, the control unit operates the function-restricting unit to restrict a predetermined function. When, for example, three or more mobile devices are carried together by the user, the possibility of misplacing two or more mobile devices at the same time is low. When two or more mobile devices are no longer detected, by restricting a predetermined function of the mobile devices, a misplaced mobile device can be prevented from being used by someone else. In contrast, when two or more mobile devices are misplaced, a function of the mobile devices being carried is restricted, allowing the user to quickly notice the misplacement.

Each of the above-described aspects may be combined within the scope of the invention.

The mobile device system or the mobile device are advantageous in that even when the user carries a different combination of mobile devices on different days, the system can flexibly respond to those situations and prevent the user from forgetting to take their mobile device when going out.

Embodiments of the mobile device system will be described below with reference to the drawings.

### FIRST EMBODIMENT

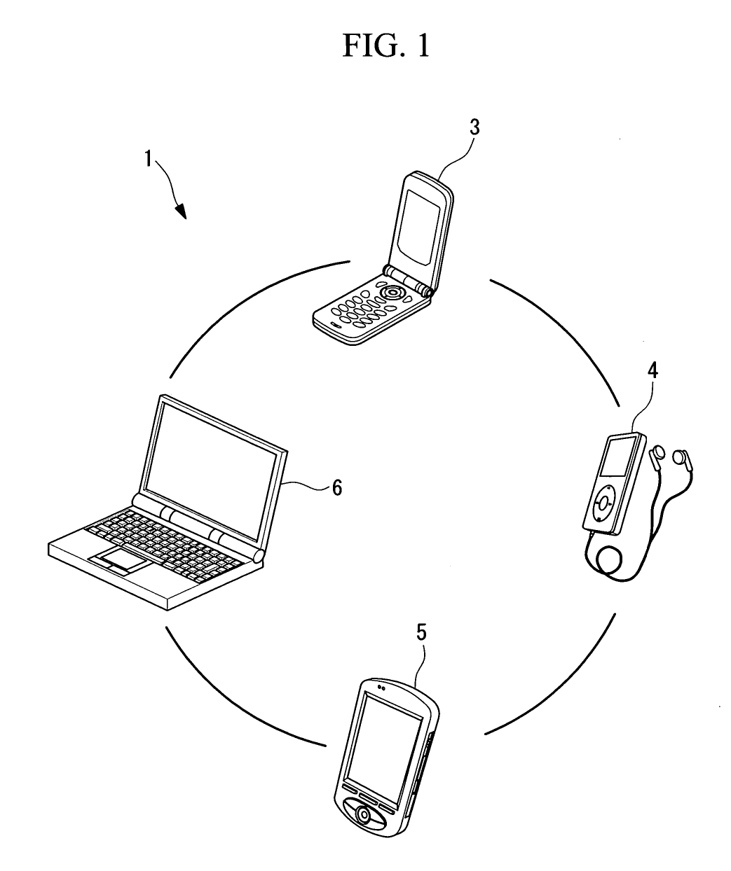

FIG. 1 illustrates the structure of a mobile device system 1 according to a first embodiment. As shown in the drawing, the mobile device system 1 includes a plurality of mobile devices or, more specifically, a mobile phone 3, a portable music player 4, a personal digital assistant (PDA) 5, and a laptop personal computer (hereinafter referred to as “computer”) 6. These mobile devices are only examples, and any type of portable electronic device may be used in any combination.

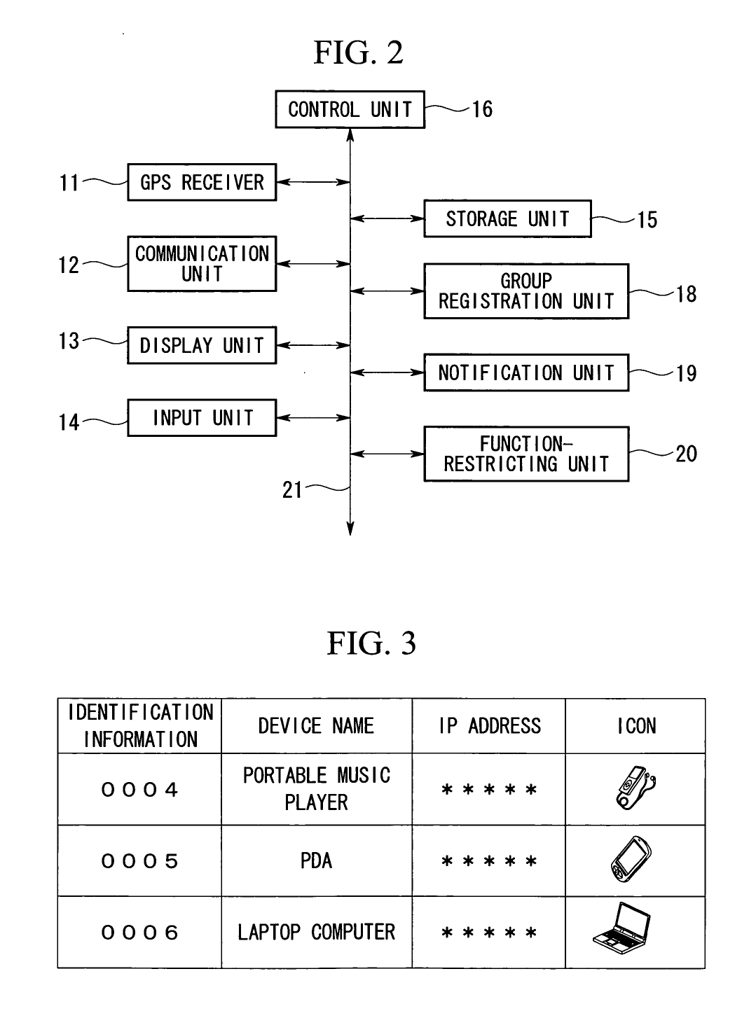

Each of the above-described mobile devices includes the following common components. More specifically, as illustrated in FIG. 2, each mobile device includes a GPS receiver (location-information acquisition unit) 11, a communication unit (communication device) 12, a display unit 13, an input unit 14, a storage unit 15, a control unit (control device) 16, a group registration unit (group registration device) 18, a notification unit 19, and a function-restricting unit (function-restricting device) 20. These units are mutually connected via a bus 21 and are capable of sending and receiving information between each other.

These components may be provided separately from components that are generally included in each mobile device, or the components that are generally included in each mobile device may also serve as the above-described components. For example, since the mobile phone 3 generally includes a communication unit, a display unit, and an input unit, any of these units that are the same as the common components may preferably be shared. This also applies to the other mobile devices.

The GPS receiver 11 periodically receives a signal from a GPS satellite, acquires location information of its mobile device on the basis of the received signal, and outputs the location information to the control unit 16.

The communication unit 12 is capable of communicating with other mobile devices by wireless communication. For example, the communication unit 12 of the mobile phone 3 is capable of communicating with the portable music player 4, the PDA 5, and the computer 6, respectively.

The display unit 13 is, for example, a liquid crystal display. The input unit 14 is, for example, keyboards or buttons and functions as a man-machine interface.

The storage unit 15 holds information about other mobile devices and location information about a registration cancellation area.

The information about other mobile devices includes identification information of each mobile device. Various kinds of information, including the device name, information for enabling two-way communication, and image data to be displayed on the display unit 13, are linked to the identification information of each mobile device. The information for enabling two-way communication is, for example, an IP address of the other party. The image data displayed on the display unit 13 is, for example, icons or character information. For example, as shown in FIG. 3, identification information of the portable music player 4, the PDA 5, and the computer 6 is stored in the storage unit 15 of the mobile phone 3 as the information of other mobile devices. The device name, IP address, and image data to be displayed on the display unit 13 are linked to each of the identification information.

The control unit 16 performs overall control of the above-described units and, as described below, has a device-detection function (device detection unit) and a registration-cancellation-area-detection function (registration-cancellation-area detection unit).

Identification information of the other mobile devices located within a predetermined range of the mobile device is registered in the group registration unit 18 as a group.

The notification unit 19 is means for notifying a user about misplacement and, for example, is an illumination function, such as an LED, for notifying by illuminating, an audio output function, such as a speaker, for notifying by an audio sound, or a vibration function, such as a vibrator, for notifying by vibration.

The function-restricting unit 20 restricts a predetermined function of the mobile device when the number of the other mobile devices located within a predetermined range decreases by two or more. The predetermined function is, for example, a reception function, a transmission function, a display function, a playback function, or a data-readout function. The predetermined function may be selected by the user. Furthermore, the function to be restricted may differ depending on the mobile device.

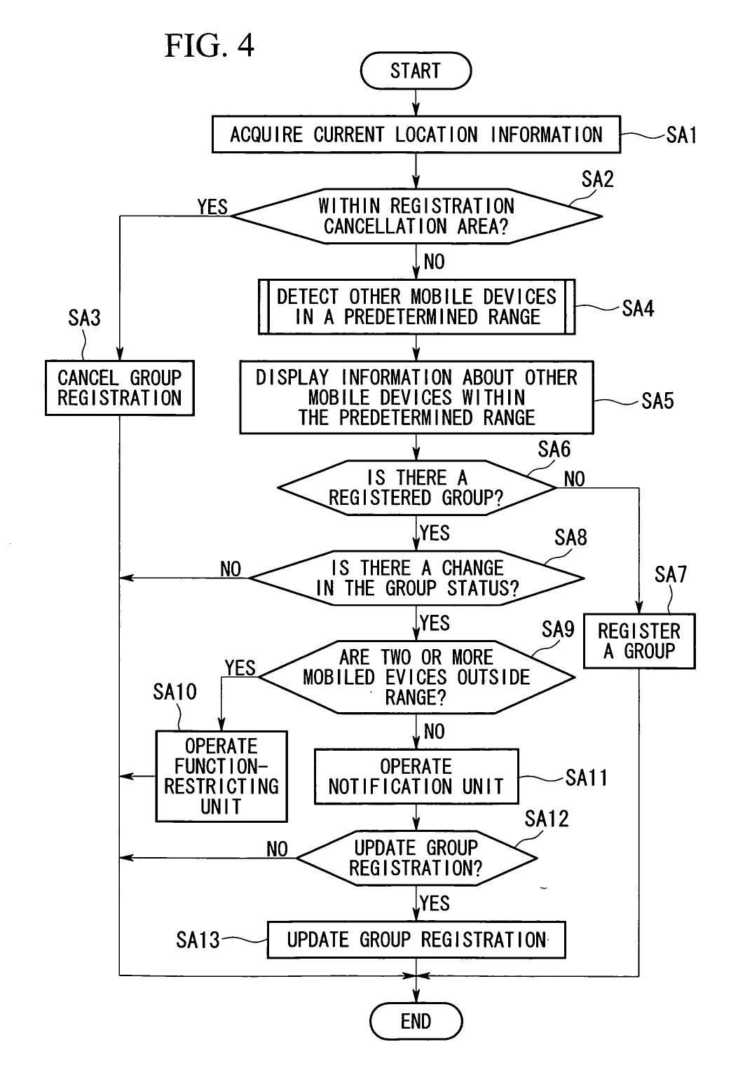

In the mobile devices having such common structures, the control units 16 repeatedly execute a misplacement detection process, as shown in FIG. 4, at predetermined intervals. Although the process described below is executed in the control unit 16 of each mobile device, for simplification, the process executed by the control unit 16 of the mobile phone 3 will be described as a representative example.

First, when location information acquired by the GPS receiver 11 is input to the control unit 16 of the mobile phone 3 (Step SA1 of FIG. 4), it is determined whether this location information belongs to the registration cancellation area registered in the storage unit 15 in advance (Step SA2). If, as a result, it is determined that the current location belongs to the registration cancellation area (YES in Step SA2), group registration in the group registration unit 18 is cancelled (Step SA3), and the process ends.

On the other hand, in Step SA2, if it is determined that location information does not belong to the registration cancellation area, the control unit 16 carries out a device detection process to detect other mobile devices located within a predetermined range of the mobile device (Step SA4).

In this device detection process, the control unit 16 first sends information linking the location information acquired by the GPS receiver 11 in Step SA1 to identification information “0003” of the mobile device to the other mobile devices from the communication unit 12. In this way, the current location information and the identification information of the mobile phone 3 are sent to the portable music player 4, the PDA 5, and the computer 6. At the same time, the same process is executed in the control units 16 of the portable music player 4, the PDA 5, and the computer 6 so as to mutually send and receive the current location information of the mobile devices. In this way, the communication unit 12 of the mobile phone 3 receives the identification information and the current location information of the portable music player 4, the PDA 5, and the computer 6.

Subsequently, on the basis of the received current location information of the portable music player 4, the PDA 5, and the computer 6 and the current location information of the mobile device, the control unit 16 determines whether or not other mobile devices are located within a predetermined range of the mobile device to detect the other mobile devices located within the predetermined range. Here, the predetermined range is a range for determining whether other mobile devices are carried together with a certain mobile device and can be set arbitrarily according to the design. For example, the range can be set between approximately 3 and 5 m.

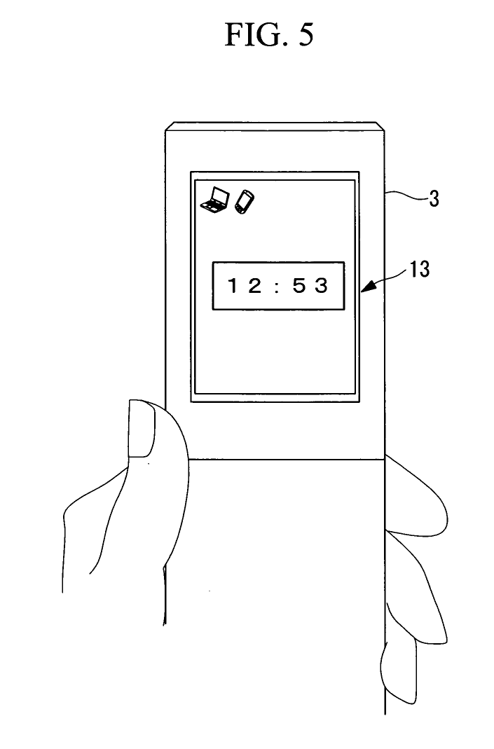

Then, the control unit 16 acquires icons linked to the identification information of the other mobile devices determined to be located within the predetermined range from the storage unit 15 and displays the icons on the display unit 13 (Step SA5). In this way, icons of the other mobile devices located within the predetermined range of the mobile phone 3 are displayed on the display unit 13. For example, FIG. 5 illustrates an example display on the display unit 13 when the PDA 5 and the computer 6 are determined to be located within the predetermined range.

Subsequently, the control unit 16 determines whether or not a group has been registered in the group registration unit 18 (Step SA6). As a result, if a group is not registered (NO in Step SA6), the other mobile devices detected in Step SA4 are registered in the group registration unit 18 as a group (Step SA7), and the process ends.

Then, in Step SA6, if a group is already registered in the group registration unit 18 (YES in Step SA6), it is determined whether there is a change in the group status (Step SA8). More specifically, it is determined whether or not the combination of mobile devices determined to be located within the predetermined range of the mobile phone 3 in this process, i.e., the above-described Step SA4, matches the combination of mobile devices registered as a group in the group registration unit 18. As a result, if both combinations match (NO in Step SA8), it is determined that there is no change in the group status, and the process ends.

On the other hand, when there is a change in the combination of mobile devices determined to be located within the predetermined range of the mobile device (YES in Step SA8), it is determined whether or not two or more other mobile devices exist outside the predetermined range of the mobile device (Step SA9). As a result, if two or more other mobile devices are outside the predetermined range of the mobile device (YES in Step SA9), it can be determined that the mobile device has been misplaced by the user, and the control unit 16 operates the function-restricting unit 20 (Step SA10). Then, the process ends. In this way, the mobile device can be prevented from being used by someone else.

If the number of other mobile devices outside the predetermined range is not two or more (NO in Step SA9), the other mobile device outside the predetermined range can be determined to be misplaced, and the control unit 16 operates the notification unit 19 (Step SA11). By this notification, the user can quickly notice that a mobile device has been misplaced. Subsequently, the control unit 16 queries the user as to whether or not to update the group registration (Step SA12). This inquiry is carried out by, for example, displaying a message “Update group registration?” on the display unit 13 or providing an audio message. If, as a result, there is an input for updating the group registration (YES in Step SA12), the mobile devices detected in Step SA4 of the process are registered as a group in the group registration unit 18 (Step SA13), and then the process ends. If there is an input for not updating the group registration in Step SA12 (NO in Step SA12), the control unit 16 does not update the group registration, and then the process ends.

Here, for example, when the user decides to increase the number of mobile devices he or she is carrying or when the user leaves a mobile device behind, then misplacement of a mobile device must be determined on the basis of the new combination of mobile devices. If the group registration is not updated, the same notification would be provided the next time the process is executed, and the user would be bothered. Thus, as described above, convenience can be enhanced by allowing the user to determine whether or not to update the group registration.

Then, the control unit 16 repeatedly executes the misplacement detection process, as shown in FIG. 4, at set intervals to periodically detect misplacement of a mobile device. When misplacement is detected, the function-restricting unit 20 is operated in the misplaced mobile device to restrict a predetermined function, whereas the notification unit 19 is operated in the mobile devices which are not misplaced to notify the user.

Next, the above-described misplacement process will be described with specific examples. In the description below, the control unit 16 of the mobile phone 3 will be described as a representative example, in the same manner as described above, and a case in which the vicinity of the user's home is registered as a registration cancellation area will be described.

First, when the user is at home and the mobile devices are placed at the user's home, since the mobile devices are determined to be in the registration cancellation area in Step SA2 (YES in Step SA2), a group registration cancellation state is maintained. In this state, when the user carries the mobile phone 3, the PDA 5, and the computer 6 and leaves his or her home, the location information acquired by the GPS receiver 11 in each mobile device is determined to be outside the registration cancellation area (NO in Step SA2), and the device detection process is carried out by the control unit 16 (Step SA4). In this way, in each mobile device, other mobile devices located within a predetermined range of that mobile device are detected, and the detected other mobile devices are displayed on the display unit 13 (Step SA5). As a result, for example, in the mobile phone 3, the PDA 5 and the computer 6 are detected as other mobile devices located within a predetermined range of the mobile phone 3, and icons of these are displayed on the display unit 13 of the mobile phone 3. In this way, the user can easily confirm which other mobile devices he or she is carrying by viewing the display unit 13 of a certain mobile device, without searching his or her bag and clothes.

Subsequently, the control unit 16 determines whether a group is registered in the group registration unit 18 (Step SA6). Here, since a group is not registered, the control unit 16 registers the other mobile devices detected in Step SA4, i.e., the PDA 5 and the computer 6, as a group in the group registration unit 18, and the process ends.

Then, at the predetermined intervals, the control unit 16 repeatedly executes the misplacement detection process to detect, in each mobile device, whether the mobile devices registered as a group are located within a predetermined range of the mobile device.

In such a case, if the user misplaces the PDA 5, in each mobile device, it is determined that there is a change in the group status in Step SA8 of FIG. 4. Subsequently, in Step SA9, it is determined whether or not two or more mobile devices are outside the predetermined range. As a result, for the misplaced PDA 5, YES is selected in Step SA9 since two mobile devices, i.e., the mobile phone 3 and the computer 6, are outside the predetermined range of the PDA 5. Accordingly, the control unit 16 of the misplaced PDA 5 operates the function-restricting unit 20 to restrict a predetermined function. In this way, the PDA 5 can be prevented from being used by someone else.

In the control units 16 of the mobile phone 3 and the computer 6, NO is selected in Step SA9 in FIG. 4, and the notification units 19 are operated in Step SA11. In this way, misplacement of a mobile device is notified to the user. Then, the control unit 16 of the mobile phone 3 and the computer 6 query whether or not to update the group registration (Step SA12) and carry out a process corresponding to the response. Then, the process ends.

As described above, in the above-described mobile device system 1, when a mobile device moves outside a registration cancellation area, other mobile devices carried together with the mobile device are detected and are registered as a group in the group registration unit 18. Therefore, even when the user carries a different combination of mobile devices on different days, the system can flexibly respond to those situations.

When two or more mobile devices among the mobile devices registered as a group are outside a predetermined range of a certain mobile device, the function-restricting unit 20 of the mobile device is operated, and the misplaced mobile device can be prevented from being used by someone else. Moreover, in the mobile devices which are not misplaced, the notification units 19 are operated, and misplacement of a mobile device can be quickly notified to the user.

According to this embodiment, in Step SA8 in FIG. 4, whether or not the group status has changed is determined on the basis of whether or not the combination of identification information registered in the group registration unit 18 matches the combination of identification information of the mobile devices detected in Step SA4. Instead, however, it can be determined whether or not the group status has changed on the basis of whether or not the number of identification information items registered in the group registration unit 18 matches the number of identification information items of the mobile devices detected in Step SA4. Similarly, in Step SA9, determination can be based on a change in the total number of mobile devices. In this way, the processing load can be reduced.

Each mobile device may be configured such that the registration cancellation area can be arbitrarily registered by the user operating the input unit 14. This registration may be carried out by, for example, displaying map information installed in the mobile device on the display unit 13 and the user operating the input unit 14 to assign a location on the map to be registered as a registration cancellation area. When the user is actually at the location to be registered, the location information acquired by the GPS receiver 11 may be registered as a registration cancellation area by operating the input unit 14 at that location.

### SECOND EMBODIMENT

Next, a mobile device system according to a second embodiment will be described.

In the above-described mobile device system according to the first embodiment, other mobile devices located within a predetermined range are detected on the basis of location information of other mobile device and location information of a certain mobile device. In this mobile device system, other mobile devices are detected using short-range communication. Hereinafter, components that are the same as those shown in FIG. 2 are represented by the same reference numeral, and only the differences are described.

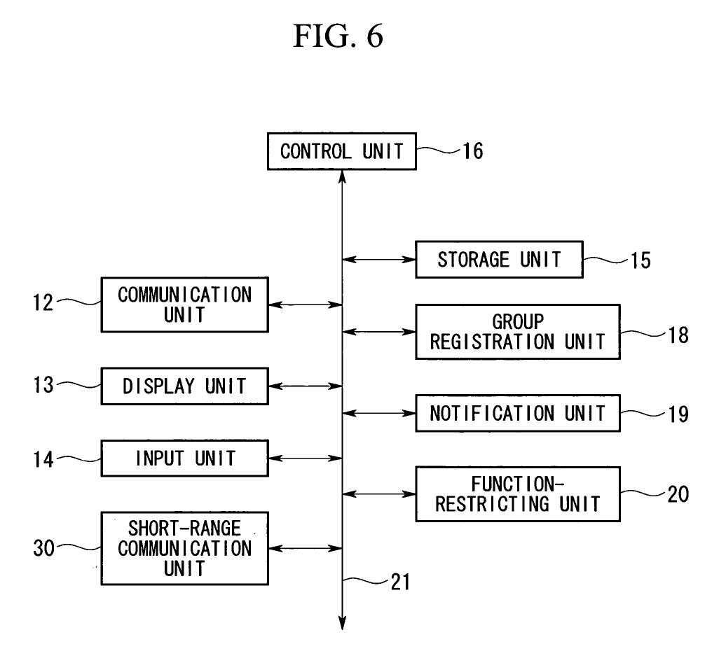

Each mobile device forming the mobile device system further includes a short-range communication unit 30, as shown in FIG. 6. The short-range communication unit 30 is capable of carrying out wireless communication with other mobile devices located in the vicinity. It is preferable that the communication range of the short-range communication unit 30 be set to a range that allows communication among the mobile devices being carried together or, for example, about 1 to 10 m. As the short-range communication unit 30, a known short-range communication device may be employed; for example, a communication device capable of communication using light such as infrared rays or a communication device, such as Bluetooth, capable of communication using radio waves may be employed.

In each of the mobile devices having the above-described common structure, the control unit 16 sends identification information assigned to the mobile device using the short-range communication unit 30 in the device detection process carried out in Step SA4 in FIG. 4. In this way, the identification information of each mobile device is received by the other mobile devices located within the communication range of the short-range communication unit 30. In this way, mobile devices close to each other can receive identification information of the other mobile devices. Therefore, the control unit 16 detects other mobile devices located in the vicinity on the basis of whether or not identification information of other mobile devices is received.

According to this mobile device system, other mobile devices located within a predetermined range of a certain mobile device can be detected without using location information.

Embodiments of the mobile device system and mobile devices have been described above in detail with reference with the drawings. However, specific structures are not limited to the above-described embodiments, and modifications are possible so long as they do not depart from the spirit of the invention.

What is claimed is:

1. A mobile device system comprising:
three or more mobile devices,
wherein each mobile device includes
a device detection unit for periodically detecting other mobile devices located within a predetermined range of the mobile device,
a function-restricting unit for restricting a predetermined function, and
a control unit, and
wherein, when two or more mobile devices of the other mobile devices detected by the device detection unit are no longer detected, the control unit operates the function-restricting unit.

2. The mobile device system according to claim 1, wherein the control unit of each mobile device operates the function-restricting unit when a state in which two or more other mobile devices are not detected by the device detection unit is maintained for a predetermined period.

3. The mobile device system according to claim 1,
wherein each mobile device further includes a group registration unit for registering the other mobile devices detected by the device detection unit as a group, and
wherein the control unit of each mobile device operates the function-restricting unit when two or more other mobile devices of the other mobile devices registered as a group in the group registration unit are no longer detected by the device detection unit.

4. The mobile device system according to claim 3,
wherein each mobile device further includes a registration-cancellation-area detection unit for detecting a registration cancellation area, and
wherein, when the registration-cancellation-area detection unit detects that the mobile device is in the registration cancellation area, the control unit cancels group registration in the group registration unit, and when the registration-cancellation-area detection unit detects that the mobile device is not in the registration cancellation area, other mobile devices detected by the device detection unit are registered as a group in the group registration unit.

5. The mobile device system according to claim 1,
wherein each mobile device further includes a location-information acquisition unit for acquiring location information of the mobile device and a communication unit for communicating with other mobile devices, and
wherein the device detection unit of each mobile device sends the location information acquired by the location-information acquisition unit to other mobile devices using the communication unit and detects other mobile devices located within a predetermined range of the mobile device on the basis of location information of the other mobile devices received by the communication unit and the location information of the mobile device.

6. The mobile device system according to claim 1,
wherein each mobile device further includes a short-range communication unit, and
wherein the device detection unit of each mobile device sends identification information assigned to that mobile device using the short-range communication unit and detects other mobile devices located within a predetermined range of that mobile device on the basis of whether or not identification information of other mobile devices is received by the short-range communication unit.

7. A mobile device comprising:
a device detection unit for periodically detecting other mobile devices located within a predetermined range of the mobile device;
a function-restricting unit for restricting a predetermined function; and
a control unit,
wherein, when two or more mobile devices of the other mobile devices detected by the device detection unit are no longer detected, the control unit operates the function-restricting unit.
